(19) United States
(12) Patent Application Publication
(10) Pub. No.: US 2015/0066699 A1
(43) Pub. Date: Mar. 5, 2015

(54) PROMOTIONAL TECHNIQUES FOR NEW MUSIC ARTISTS

(71) Applicant: TrueMuze, Inc., San Jose, CA (US)

(72) Inventor: Heidi K. Fisher, San Jose, CA (US)

(73) Assignee: TrueMuze, Inc., San Jose, CA (US)

(21) Appl. No.: 14/015,534

(22) Filed: Aug. 30, 2013

(51) Int. Cl. G06Q 30/06

(52) U.S. Cl. CPC G06Q 30/0623
USPC 705/26.61

(57) ABSTRACT

In various embodiments, a computer-implemented method for a music discovery platform is disclosed. The method comprises displaying, by a processor, a virtual scene. The virtual scene comprises one or more venues. The method further comprises receiving, by the processor, a selection of a first venue and displaying, by the processor, the first venue. The first venue comprises a venue type. The method further comprises playing, by an audiovisual system, a performance. The performance comprises a performance type.

### BACKGROUND

With the increase in popularity of the internet, bands and artist are able to share and distribute music without accessing traditional distribution companies or channels. However, barriers to distribution remain for unknown or new music artists. Although artists can attempt to sell or distribute music and performances from a personal website, without a portal for individuals to discover new music and musicians, unknown artists may never be discovered. In addition, with the rise of digital distribution, traditional locations for local music performance may be less frequented by those seeking to discover new music.

### SUMMARY

In various embodiments, a computer-implemented method for a music discovery platform is disclosed. The method comprises displaying, by a processor, a virtual scene. The virtual scene comprises one or more performance venues. The method further comprises receiving, by the processor, a selection of a first venue and displaying, by the processor, the first venue. The first venue comprises a venue type. The method further comprises playing, by an audiovisual system, a performance. The performance comprises a performance type.

In various embodiments, a computing device is disclosed. The computing device comprises a processor and a non-transitory computer-readable medium coupled to the processor. The non-transitory computer-readable medium is configured to store computer program instructions that when executed by the processor are operable to cause the processor to: display a virtual scene, receive a selection of a first venue, display the first venue, and play a performance. The virtual scene comprises one or more venues. The first venue comprises a venue type. The performance comprises a performance type.

In various embodiments, a computer-implemented method for promotion of new music is disclosed. The method comprises providing, by a server, a virtual scene to a client device. The virtual scene comprises at least one venue. The method further comprises receiving, by the server, a venue selection of a first venue from the client device and providing, by the server, the first venue to the client device. The first venue comprises at least one genre type. The first venue comprises a virtual representation of at least one real-world location associated with music performances. The method further comprises providing, by the server, a performance to the client device. The performance may comprise at least one genre type. The performance is displayed on the client device within the first venue.

### FIGURES

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1 illustrates one embodiment of a client application for implementing promotional techniques for new music artists.

FIG. 2 illustrates one embodiment of a network-based promotional platform.

FIG. 3 illustrates one embodiment of an interaction process flow.

FIG. 4 illustrates one embodiment of a virtual scene.

FIG. 5 illustrates one embodiment of a subway station venue.

FIG. 6 illustrates one embodiment of a symphony hall venue.

FIG. 7 illustrates one embodiment of a college campus venue.

FIG. 8 illustrates one embodiment of an amphitheater venue.

FIG. 9 illustrates one embodiment of a coffee shop venue.

FIG. 10 illustrates one embodiment of the coffee shop venue of FIG. 9 with a performance displayed.

FIG. 11 illustrates one embodiment of the coffee shop venue of FIG. 9 with a list of performances displayed.

FIG. 12 illustrates one embodiment of the coffee shop venue of FIG. 9 with a favorite dialogue, a tip dialogue, and a flag dialogue displayed.

FIG. 13 illustrates a schematic view of an illustrative electronic device.

FIG. 14 illustrates one embodiment of an input/output subsystem for an electronic device.

FIG. 15 illustrates one embodiment of a communications interface for an electronic device.

FIG. 16 illustrates one embodiment of a memory subsystem for an electronic device.

FIG. 17 illustrates one embodiment of a computing environment for implementing a performance platform server.

### DESCRIPTION

Reference will now be made in detail to several embodiments, including embodiments showing example implementations of promotional techniques for new music artists. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

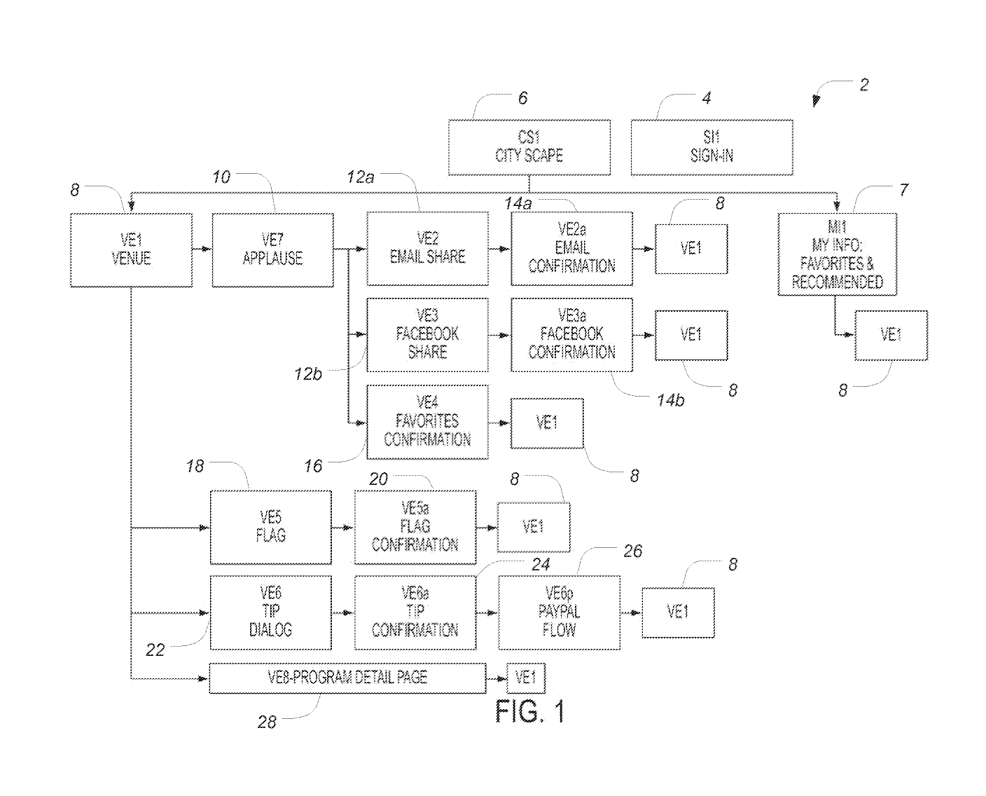

FIG. 1 illustrates one embodiment of a client application 2 for implementing promotion techniques for new music artists. In one embodiment, the client application 2 may be executed by a user device, such as, for example, a handheld or desktop computing device. For example, in some embodiments, the client application 2 may be executed by a handheld computing device such as, for example, a tablet computer and/or a Smartphone. The client application 2 may require a user to sign-in 4 to the application. The user may sign-in 4 to the application by inputting a username and/or a password into the client computing device. The client application 2 may verify the username and/or password entered by checking a locally stored copy of the username and/or password or communicating with a remote server to verify the entered username and/or password.

In some embodiments, after the user has logged in, the client application 2 may display a virtual scene 6 on the user device. For example, the virtual scene 6 may comprise a landscape, cityscape, urban landscape, map, and/or any other suitable virtual scene. The virtual scene 6 may comprise representations of manmade and/or natural structures. In some embodiments, the virtual scene 6 may illustrate a real-world location, such as, for example, a virtual representation or map of an actual city, landmark, or other location. In some embodiments, the virtual scene 6 may be related to the location of the user. For example, a user in New York City may see a virtual representation of New York City, whereas a user in Paris may see a virtual representation of Paris. In some embodiments, the user may change the scale of the virtual scene 6 by zooming in or out to view a smaller or larger section of the virtual scene 6. The virtual scene 6 may be set by the client application 2 or may be selectable by a user. The virtual scene 6 may display favorite and/or recommended venues 7. The favorite and/or recommended venues 7 may be set by the user, received from other users, and/or set by the client application in response to previous user activity.

The virtual scene may comprise one or more venues 8. A venue 8 may comprise a location within the virtual scene 6 at which a user can view one or more performances. The one or more venues 8 may be labeled and/or marked graphically to aid the user in identifying those elements of the virtual scene 6, for example a map, that are venues 8. In some embodiments, the one or more venues 8 may correspond to locations traditionally associated with music performances, such as, for example, a subway station, a college campus, a concert hall, a concert venue, a coffee shop, a street corner, and/or any other location traditionally associated with planned and/or impromptu music performances. A user may interact with the user device to select one of the venues 8. Once a user has selected a venue 8, the client application 2 may display a virtual representation of the venue 8. For example, if a user selects a coffee shop venue from the virtual scene 6, the client application may display the interior of a virtual coffee shop. A virtual representation of the venue 8 may be accomplished by, for example, an artistic rendering of the venue 8, a photograph of an actual venue, audio clips either actually from and/or representative of the type of the venue 8, video clips either actually from and/or representative of the type of venue 8, and/or colors and typographical fonts either actually from and/or representative of the type of venue 8.

In some embodiments, the selected venue 8 may comprise one or more audiovisual performances, such as, for example, a recording of a live performance, a broadcast of a live performance, a music video, or any other audiovisual performance. The audiovisual performance may be displayed in the venue 8 in a location traditionally associated with performances, such as, for example, a virtual stage. The venue 8 may display the audiovisual performance in a dedicated section of the venue 8 or may display the audiovisual performance overlaid on top of at least a portion of the venue 8.

In some embodiments, the venue 8 may be associated with one or more specific genres, or types, of music. For example, the venue 8 may be associated with one or more genres of music typically found at the real-world counterpart of the venue. The one or more genres of music may be set by the venue type, the venue location, the time of day, and/or any other variables that may affect the type of music played at a venue 8. For example, in some embodiments, a venue 8 may comprise a coffee shop venue. The coffee shop venue may be associated with genres of music typically found at coffee shops, such as, for example, solo artist, alternative artists, soft rock artists, etc. As another example, a venue 8 may comprise a symphony hall venue. The symphony hall venue may be associated with one or more genres of music typically found at a symphony hall, such as, for example, classical, orchestral, and/or chamber music. Those skilled in the art will recognize that the genres associated with a venue 8 may change based on location, popularity of certain genres, time of day, user preferences, and/or any other suitable factors.

In some embodiments, the audiovisual performance displayed in the venue 8 may correspond to at least one of the genres associated with the venue 8. For example, if a user selects a coffee shop venue, the audiovisual work displayed by the client application 2 may correspond to a genre of music associated with the coffee shop venue, such as, for example, a solo performance. In some embodiments, the genre of the audiovisual performance may be selected at random from one or more audiovisual performances matching the genres associated with the venue 8. In other embodiments, the user may identify genre preferences, and the performance displayed in the venue 8 may be selected from a genre associated with the venue that is also a user preference.

The venue 8 may comprise one or more inputs for receiving user feedback. For example, in some embodiments, the venue may comprise an input for a user to identify whether they enjoyed a displayed performance. The venue 8 may comprise, for example, an applause feedback input 10 and/or a favorite button. The applause feedback input 10 may allow a user to provide virtual applause for the performance to indicate that the user enjoyed or liked the performance. The applause feedback input 10 may comprise, for example, an applause button displayed with and/or overtop of the venue 8. In some embodiments, the applause feedback input 10 may allow a user to indicate the level of interest in the displayed performance, such as, for example, by providing various levels of applause and/or allowing a user to interact with the applause feedback input 10 multiple times.

In some embodiments, the venue 8 may comprise one or more inputs configured to allow a user to share a performance. The venue 8 may allow a user to share a performance, for example, through e-mail, social media services, chat services, and/or within the promotional platform. In some embodiments, the client application 2 may be connected to one or more outside services, such as, for example, e-mail and/or social media platforms, through one or more APIs. The venue 8 may provide an e-mail sharing input 12a and/or a social media sharing input 12b. The e-mail sharing input 12a may allow a user to e-mail information about the displayed performance, such as, for example, the name of the artist, the name of the song, and/or a link to the performance and/or to the music discovery platform web site, to one or more e-mail contacts. The client application 2 may provide an e-mail confirmation 14a to the user to verify that the user intended to send the e-mail and or to verify that the e-mail has been successfully sent. The social media sharing input 12b may allow a user to share information about the displayed performance with one or more social media contacts and/or networks. For example, in various embodiments, the client application 2 may be connected to one or more social media networks such as, for example, Twitter, Facebook, Vimeo, Vine, Google+, and/or any other suitable social media networks. The client application 2 may be configured to provide a social media confirmation 14b to verify that the user intended to share the information via social media and/or to confirm that the performance information has been successfully shared with one or more social media networks.

In some embodiments, the client application 2 may be configured to allow a user to mark one or more performances as favorite performances. For example, a venue 8 may comprise a favorite button. A user may interact with the favorite button to mark a currently playing performance as a favorite performance. The client application 2 may store favorite performances to allow the user to later retrieve a performance and/or information related to the performance. For example, the user may be able to retrieve the artist name, the song name, the genre of the performance, and/or the venue where the performance was viewed for one or more favorite performances. In some embodiments, the client application 2 may use information about one or more favorite performances to suggest additional performances to a user. For example, the client application 2 may provide additional performance suggestions to a user that match the genre, artist, and/or venue of one or more performances that the user has marked as favorites. Those skilled in the art will recognize that any suitable information from favorite performances may be used to generate additional performances for the user.

The client application 2 may provide a flag input 18 configured to allow a user to flag one or more performances as inappropriate and/or incorrectly tagged. For example, in some embodiments, the client application 2 may allow a user to identify a performance as containing inappropriate content, such as, for example, nudity, violence, abrasive language, and/or other types of inappropriate content. The client application 2 may be configured to filter content tagged as inappropriate. For example, in some embodiments, the client application 2 may be configured in an under-18 mode that filters all content that has been marked as containing nudity and/or abrasive language. A user may be able to generate custom filters to filter certain types of inappropriate content but allow other types. In some embodiments, the client application 2 may be configured to allow a user to flag 18 a performance as being incorrectly tagged, such as, for example, indicating that the performance has been placed in the wrong genre, has the wrong artist information, and/or has the wrong song name information.

In some embodiments, the client application 2 may be configured to allow a user to provide a tip to the artist associated with a performance. The venue 8 may comprise a tip input 22 that may allow users to initiate a tipping transaction. For example, a user may be able to provide a tip to the artist associated with a currently playing performance, an artist associated with a previous displayed performance, and/or any artist associated with the promotional platform. The user may interact with the tip input 22 to provide a tip to an artist in the form of a monetary donation. In some embodiments, the tip input 22 may initiate an online financial transfer between an account associated with the user and an account associated with the artist. For example, when a user indicates that they wish to provide a tip to an artist, the client application 2 may access an online payment service, such as, for example, PayPal, to initiate a transaction between an account associated with the user and an account associated with the artist.

In various embodiments, a tip may be provided through a direct transaction between the user and the artist, such as, for example, through PayPal or other monetary transfer systems, and/or may be provided by credits purchased through the client application 2. For example, in some embodiments, the client application 2 may allow a user to purchase one or more tipping credits corresponding to a certain monetary value. A user may then tip an artist by providing one or more credits to the artist. The artist may then be able to exchange the credits for a currency of their choice.

In some embodiments, a portion of a tip amount may be diverted by the client application 2 to an account associated with the promotional platform. For example, the client application 2 may take a percentage of each tip transaction, such as, for example, 10%. The client application 2 may transfer the percentage of the tip into an account associated with the promotional platform. In some embodiments, the portion of the tip diverted by the client application 2 may be set independently for each artist and/or may vary depending on the amount of the tip, or the level of interest in the artist on the promotional platform.

In some embodiments, the client application 2 may provide a tip confirmation 24 to the user to verify that the user intended to tip to the artist. After verification, the client application 2 may execute a payment flow 26 to contact a payment service, such as, for example, PayPal, to initiate a transaction between an account associated with the user and an account associated with the artist. The payment flow 26 may provide confirmation to the user that the tip amount has been successfully provided to the artist.

In some embodiments, the client application 2 may comprise a program detail page 28. The program detail page 28 may provide details regarding the performance being played, including but not limited to the artist's name and location, the venue name, artist's web site, artist's favorite instruments, artist's influences, artist's appeal message for tips, the video title and description, performance date, and performance location. Location information, including artist's location and/or performance location, may be comprised of a location name and/or physical coordinates that correspond to a map location and/or an actual venue in a specific location on a map. In some embodiments, the client application 2 may comprise user information 30. The client application 2 may store user information 30 such as, for example, user location, favorite performances of the user, social media networks and credentials for the user, payment system credentials, friend connections, or other user information. The user information 30 may also comprise suggestions or recommendations generated by the client application 2 and/or other users of the promotional platform. The user information 30 may be stored locally on the user device or may be stored remotely, such as, for example, on a server and/or in a database.

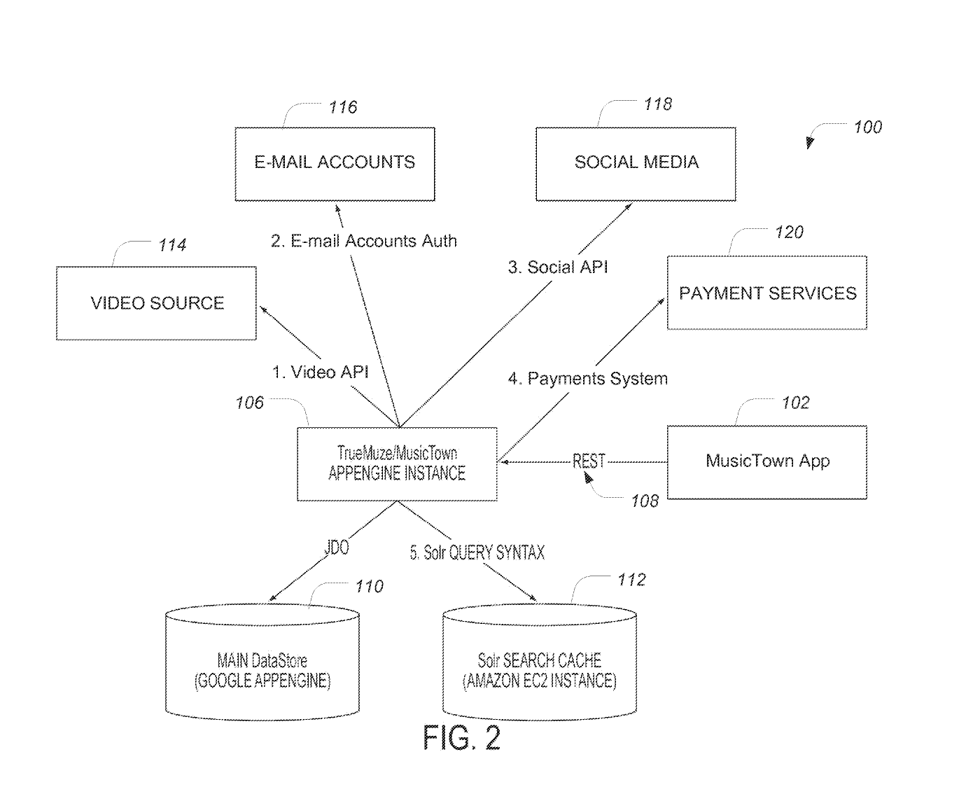

FIG. 2 illustrates one embodiment of a network-based promotional platform 100. The promotional platform 100 may be configured to interact with and/or support a client application 102. The client application 102 may be connected to a promotional platform server 106 configured to provide one or more services to the client application 102. In some embodiments, the client application 102 and the promotional platform server 106 may be connected by a representational state transfer (REST) application programming interface (API) 108. The REST API 108 may allow a single promotional platform server 106 to interact with multiple client applications 102. The promotional platform server 106 may provide the client application 102 with access to one or more services for providing content and/or facilitating user activities on the client application.

In some embodiments, the promotional platform server 106 may be connected to one or more databases 110, 112 for storing data associated with the promotional platform and/or the client application 102. For example, a main database 110 may store data, including but not limited to the user's biography, favorite music genres, instruments, musical influences, web site URL, and URL to the user's Internet music purchasing site, such as the user's iTunes store. The main database may also store user credentials for one or more client applications 102, user credentials for one or more social media, e-mail, or payment services, venue and virtual scene information, genre information, and/or any other information associated with the promotional platform and/or the client application 102. One or more additional databases may provide data required for additional functionality for the promotional platform server 106 and/or the user device 102. For example, in some embodiments, a syntax server 112 may store data associated with a specific search type, such as, for example, a syntax database to support a Solr full-text search platform. The syntax server 112 may provide necessary syntax for implementing and executing full text, ontological, and/or other types of searches for matching performances with venues, users, genres, and/or other parameters.

In some embodiments, a Solr full-text search platform may provide a platform for full-text searching, hit highlighting, faceted search, near real-time indexing, dynamic clustering, database integration, rich document handling, and/or geospatial search. Solr may be provide a highly-reliable, scalable, and fault tolerant search platform, providing distributed indexing, replication, and load-balanced querying, automated failover and recovery, and/or centralized configuration. In some embodiments, one or more alternative or additional search options may be implemented, such as, for example, a Google App Engine Search API and/or an Amazon CloudSearch platform.

In some embodiments, the promotional platform server 106 may be connected to one or more external systems for implementing functionality of the promotional platform 100 and/or the client application 102. For example, in some embodiments, the promotional platform server 106 may be in communication with one or more video services 114 for hosting and providing performances to the promotional platform and/or the client application 102. The video service 114 may comprise an external video hosting service, such as, for example, YouTube, Vimeo, Vine, and/or any other video hosting service. In some embodiments, the promotional platform server 106 may be connected to the video service 114 through a video service API provided by the video service 114. The video service API may allow the promotional platform 100 to pull videos, video data, metadata, and/or other information from the video service and display the videos and/or data in a venue 8 displayed in the client application 102.

In some embodiments, the promotional platform server 106 may be in communication with one or more e-mail accounts 116. The one or more e-mail accounts may allow the promotional platform 100 to share videos, user preferences, suggestions, and/or other information through a user e-mail account provided by the user. The promotional platform server 106 may utilize one or more account authorization interfaces to connect a user e-mail account to the promotional platform 100. For example, if a user wishes to connect a Google e-mail account with the promotional platform 100, the promotional platform server 106 may interact with a Google Account Authorization service to authenticate the user's Google credentials and connect the user's Google account to the promotional platform 100. Those skilled in the art will recognize that if a different e-mail service is interfaced with the promotional platform, a different account authorization service would need to be utilized.

The promotional platform 100 may allow a user to connect to one or more social media platforms 118. In some embodiments, the promotional platform server 106 may be in communication with one or more social media platforms 118 to allow the promotional platform 100 and/or a client application 102 to send information to and receive information from one or more of the user's social media platforms 118. The promotional platform server 106 may be in communication with one or more social media platforms 118 through one or more social media APIs, such as, for example, a Facebook Graph API, a Twitter API, or any other suitable API. In some embodiments, the type of information shareable with a social media platform 118 may be set by the social media platform 118. For example, a user may be limited to sharing one of a link to a performance, an artist name, or a song name to a first social media platform, such as, for example, Twitter. However, the user may be able to share additional information with a second social media platform, such as, for example, Facebook.

The promotional platform 100 may be in communication with one or more payment services 120 to facilitate tip transactions within the promotional platform 100 and/or the client application 102. In some embodiments, the promotional platform server 106 may facilitate communication between the promotional platform 100, the client application 102 and one or more payment services 120 through one or more payment APIs. The payment APIs may be provided by the payment services, such as, for example, a PayPal Adaptive Payments API provided by PayPal. Other APIs may be used to interface with other payment services. In some embodiments, the promotional platform 100 may be in communication with a plurality of payment services 120. A user may select which payment service 120 to use to complete a tip payment transaction.

In some embodiments, the promotional platform 100 data may be stored in a cloud-based storage platform, such as, for example, a Google App Engine data store implemented via a Java data objects (JDO) interface. JDO is a standard interface for storing objects containing data into a database. The standard defines interfaces for annotating Java objects, retrieving objects with queries, and interacting with a database using transactions. The promotional platform 100 may implement one or more Java Data Objects for implementing the promotional platform 100 and/or the client application 102.

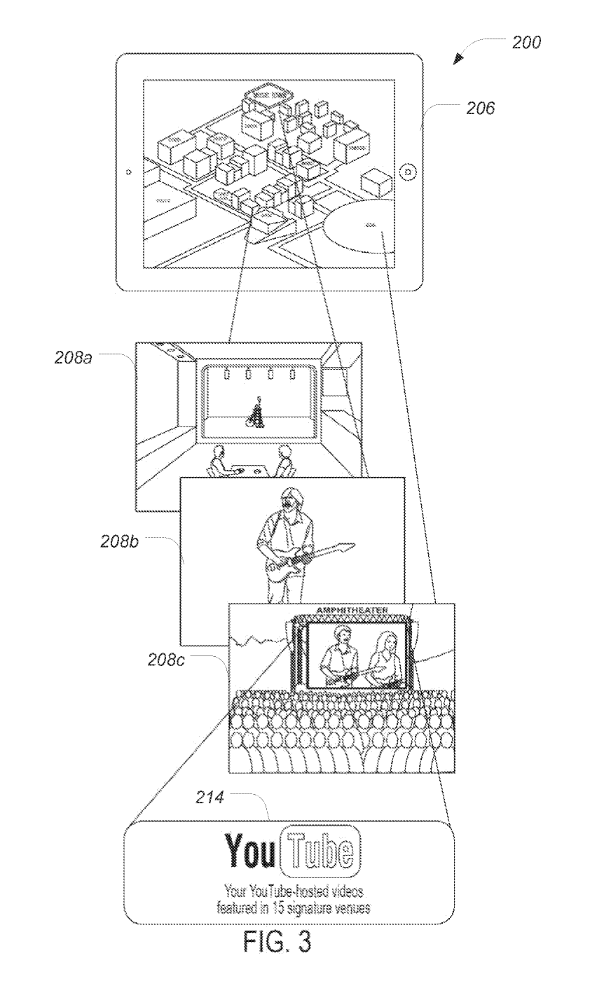

FIG. 3 illustrates one embodiment of an interaction process flow 200. A user device 220 may execute a client application, such as, for example, the client application 2 of FIG. 1, to display a virtual scene 206. The virtual scene 206 may comprise a landscape, cityscape, urban landscape, and/or other suitable scene. For example, the virtual scene 206 may comprise a cityscape of virtual town. The virtual scene 206 may comprise one or more venues 208a-208c. The venues 208a-208c may comprise locations for viewing and discovering music and performances. In some embodiments, the venues 208a-208c may correspond to one or more real-world locations usually associated with musical performances, such as, for example, a bar 208a, a garage 208b, or a stadium 208c. One or more additional venues may be included in the virtual scene 206, such as, for example, coffee shops, street corners, subway stations, college campuses, symphony halls, festival grounds, and/or any other suitable venue for displaying and/or discovering music.

In some embodiments, a user may interact with the virtual scene 206 displayed on the user device 220 to select a venue 208a-208c. The user may interact with the virtual scene 206a through any suitable input device coupled to and/or integral with the user device 220. For example, in some embodiments, the user may select a venue 208a-208c from the virtual scene 206 through a touch screen interface built into the user device 220. In some embodiments, one or more additional input devices may be used to interact with the virtual scene 206 displayed by the user device 220. When a user selects a venue 208a-208c, such as, for example, the stadium venue 208c, the user device 220 displays the venue 208c to the user. The venue 208c may comprise one or more performances 222.

In some embodiments, the one or more performances 222 may correspond to one or more genres associated with the venue 208c. For example, in some embodiments, a stadium venue 208c may be associated with one or more genres of music typically performed in a stadium environment, such as, for example, rock, pop, and/or other genres associated with a stadium-style venue. The client application 102 may provide default genres for each of the venues 208a-208c included in the virtual scene 206. In some embodiments, the user may alter the genres associated with one or more venues 208a-208c to reflect the user's personal taste.

In some embodiments, the one or more performances 222 may begin playing when the user selects the venue 208c from the virtual scene 206. For example, when the user selects the venue 208c on the user device 220, the user device 220 may load a performance 222 from a list of performances associated with the selected venue 208c. The performance 222 may be loaded through one or more APIs 232 associated with video and/or audio hosting services, such as, for example, YouTube, Vimeo, and/or any other video or audio hosting service. In some embodiments, the performances 222 associated with the venue 208c may play continuously within the venue 208c. For example, if a user selects a venue 208c, the user device 220 may load the venue 208c. The performance 222 may load at a specific point as though the performance 222 had been continuously playing prior to the user selecting the venue 208c. By loading the performance 222 in this way, the client application 2 may generate the impression of a virtual concert going on while the user explores other venues.

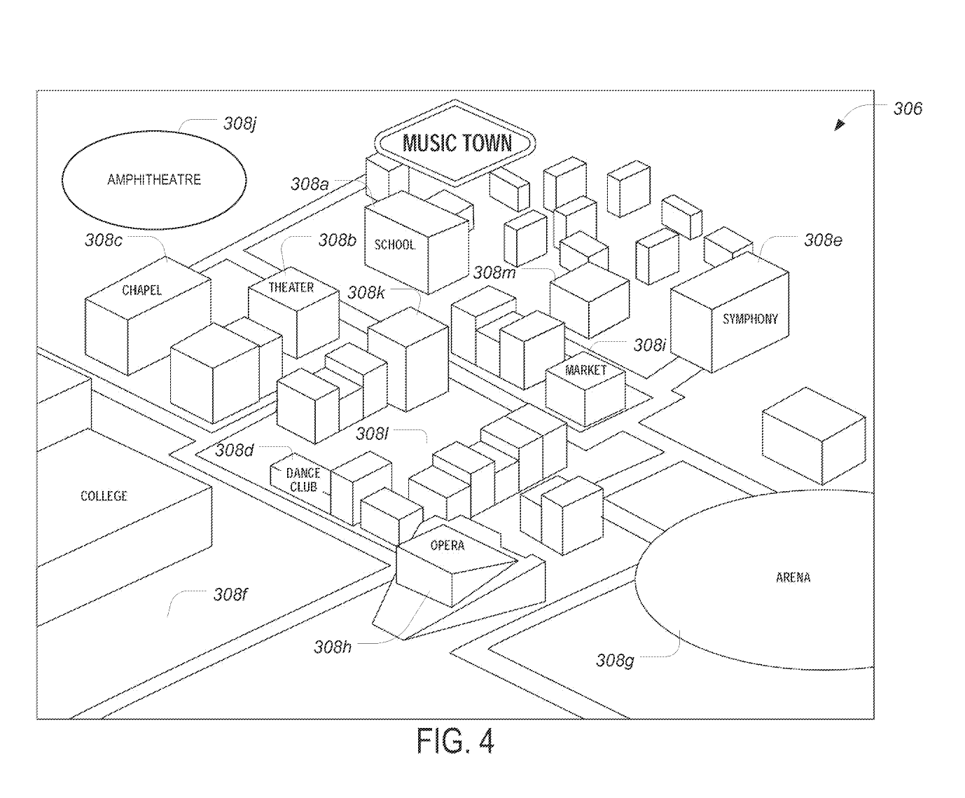

FIG. 4 illustrates one embodiment of a virtual scene 306 that may be displayed by a client application 2. The virtual scene 306 may comprise a landscape, a cityscape, or any other suitable scene. The virtual scene 306 may comprise one or more venues 308a-308m. The venues 308a-308m may be labeled and/or marked graphically to aid the user in identifying those elements of the virtual scene, or map, that are venues 308a-308m. The one or more venues 308a-308m may have one or more genres of music associated with each of the venues 308a-308m. For example, in some embodiments, the symphony venue 308e may be associated with, for example, classical, orchestral, and/or chamber music. As another example, the college campus venue 308f may be associated with solo artists, small bands, and/or other genres of music typically found on a college campus. A user may select a venue 308a-308m from the virtual scene 306. The client application 2 may load the venue 308a-308m and a performance associated with the venue 308a-308m and/or the genre of music associated with the venue 308a-308m. In some embodiments, the client application 2 may provide information about each venue 308a-308m to the user, for example, identifying the genres associated with the venue 308a-308m, performances displayed in the venue 308a-308m, and/or the number of users who have visited the venue 308a-308m.

In some embodiments, the virtual scene 306 may illustrate a real-world location, such as, for example, a city. For example, the virtual scene 306 may comprise a virtual representation or map of a city, such as, for example, New York, Paris, Tokyo, or any other location. In some embodiments, the client application 2 may automatically select the city to display based on the location of the user device 220. For example, if a user is located in or near New York City, the client application 2 may select New York City to be represented in the virtual scene 306. In some embodiments, a user may select a real-world location to be represented in the virtual scene 306. For example, a user may select a specific city to be displayed or may select a method for selecting the virtual scene 306. For example, in one embodiment, a user may elect to follow a band while the band is on tour. The virtual scene 306 may change based on the real-world location of the band. For example, if the band is performing in Los Angeles, the virtual scene 306 may display a representation of Los Angeles. If the band moves to Chicago for a performance, the virtual scene 306 may update to display Chicago.

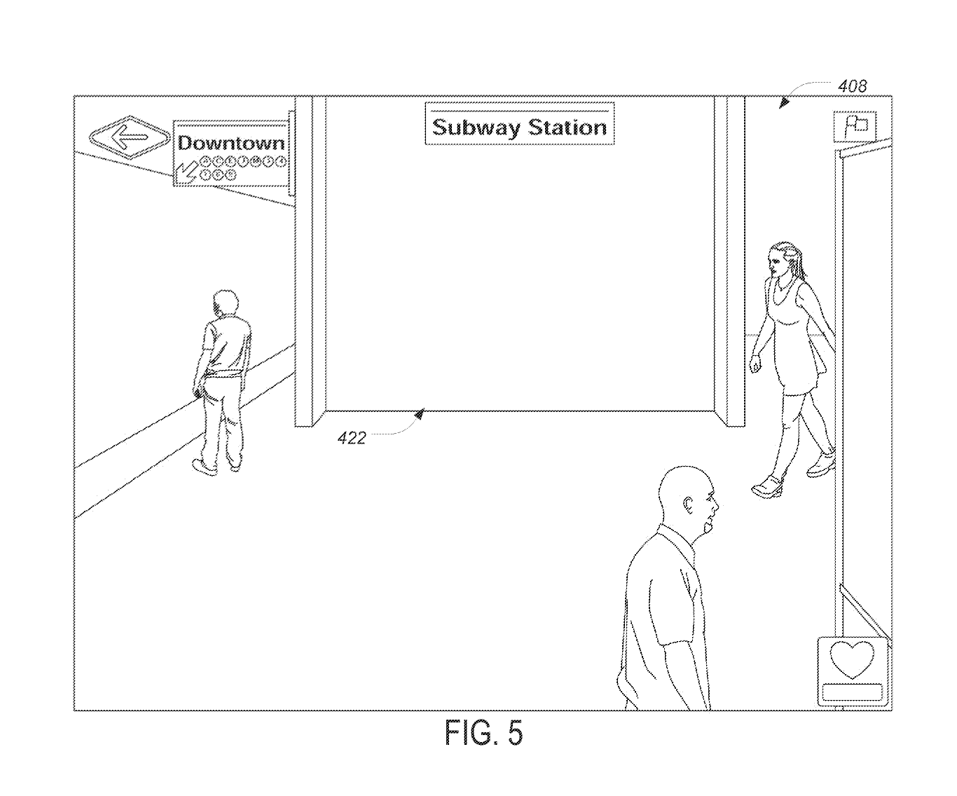

FIGS. 5-9 illustrate various embodiments of venues that may be included in the virtual scene 306. FIG. 5 illustrates one embodiment of a subway station venue 408. The subway station venue 408 may comprise a virtual representation of a subway station. The subway station venue 408 may illustrate a generic subway station or may illustrate a subway station associated with the virtual scene 306. For example, if the virtual scene 306 illustrates New York City, the subway station venue 408 may illustrate a subway station that would be found in New York City. The subway station venue 408 may comprise a performance area 422 for displaying one or more performances. The performance area 422 may be located in an area of the subway station venue 408 that would be associated with performances in the real-world. For example, in the illustrated embodiment, the performance area 422 is located against a wall of the subway station. Those skilled in the art will recognize that the performance area 422 may be located in any suitable portion of the venue 408. The subway station venue 408 may be associated with one or more performance genres typically found in a subway, such as, for example, acoustic guitar players, solo instrument players, etc.

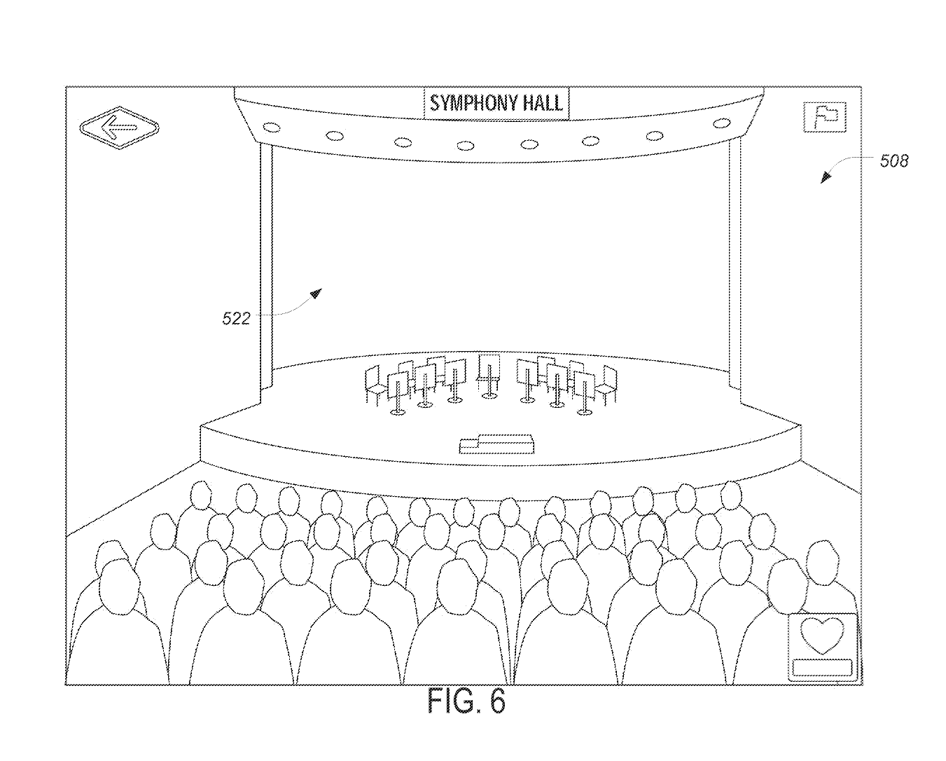

FIG. 6 illustrates one embodiment of a symphony hall venue 508. The symphony hall venue 508 may comprise a virtual representation of a generic symphony hall or may comprise a symphony hall associated with the virtual scene 306. For example, if the virtual scene 306 illustrates New York City, the symphony hall venue 508 may comprise a virtual representation of Carnegie Hall. The symphony hall venue 508 may comprise a performance area 522 for displaying one or more performances associated with the symphony hall venue 508. The performance area 522 may be located above a virtual representation of a stage 534. The symphony hall venue 508 may be associated with one or more performance genres typically found at a symphony hall, such as, for example, orchestral music, classical music, chamber music, etc.

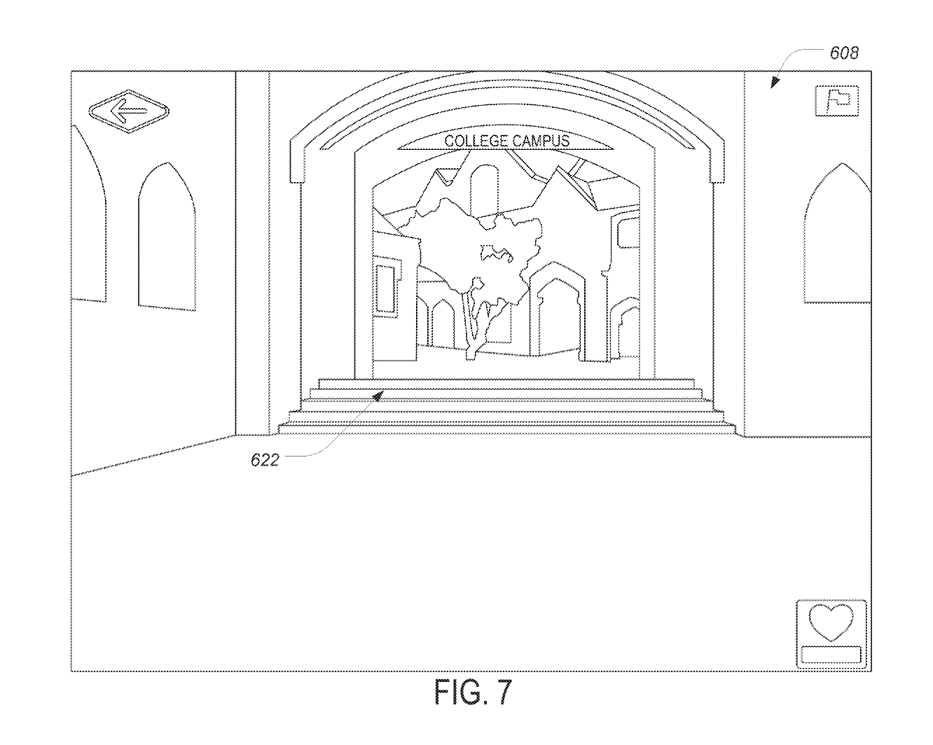

FIG. 7 illustrates one embodiment of a college campus venue 608. The college campus venue 608 may comprise a virtual representation of a generic college campus or may comprise a virtual representation of a college campus associated with the virtual scene 306. For example, if the virtual scene 306 illustrates Boston, the college campus venue 608 may comprise a virtual representation of the Harvard University campus. The college campus venue 608 may comprise a performance area 622 for displaying one or more performances associated with the college campus venue 608, such as, for example, a campus quad. In some embodiments, the college campus venue 608 may be associated with one or more performance genres typically found on a college campus, such as, for example, college bands, solo artists, acoustic performances, etc.

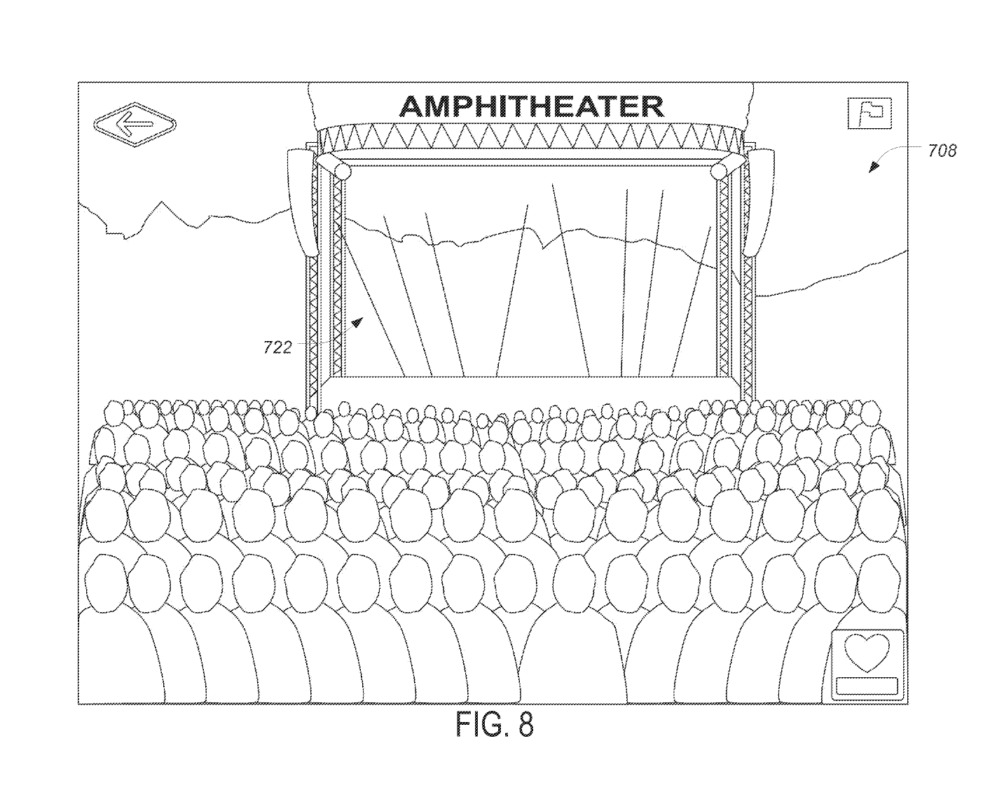

FIG. 8 illustrates one embodiment of an amphitheater venue 708. The amphitheater venue 708 may comprise a virtual representation of an amphitheater or other festival-style venue. In some embodiments, the amphitheater venue 708 may comprise a virtual representation of an amphitheater associated with the virtual scene 306. For example, if the virtual scene represents San Francisco, the amphitheater venue 708 may comprise a virtual representation of the Shoreline Amphitheatre. The amphitheater venue 708 may comprise one or more performance areas 722 for displaying performances, such as, for example, a virtual representation of a stage. In some embodiments, the amphitheater venue 708 may comprise a festival-style venue having multiple performance areas 722. A user may select a specific performance area to display a performance associated with the selected performance area. In some embodiments, the amphitheater venue 708 may be associated with one or more performance genres typically associated with amphitheaters, such as, for example, top 40 artists, rock artists, pop artists, etc.

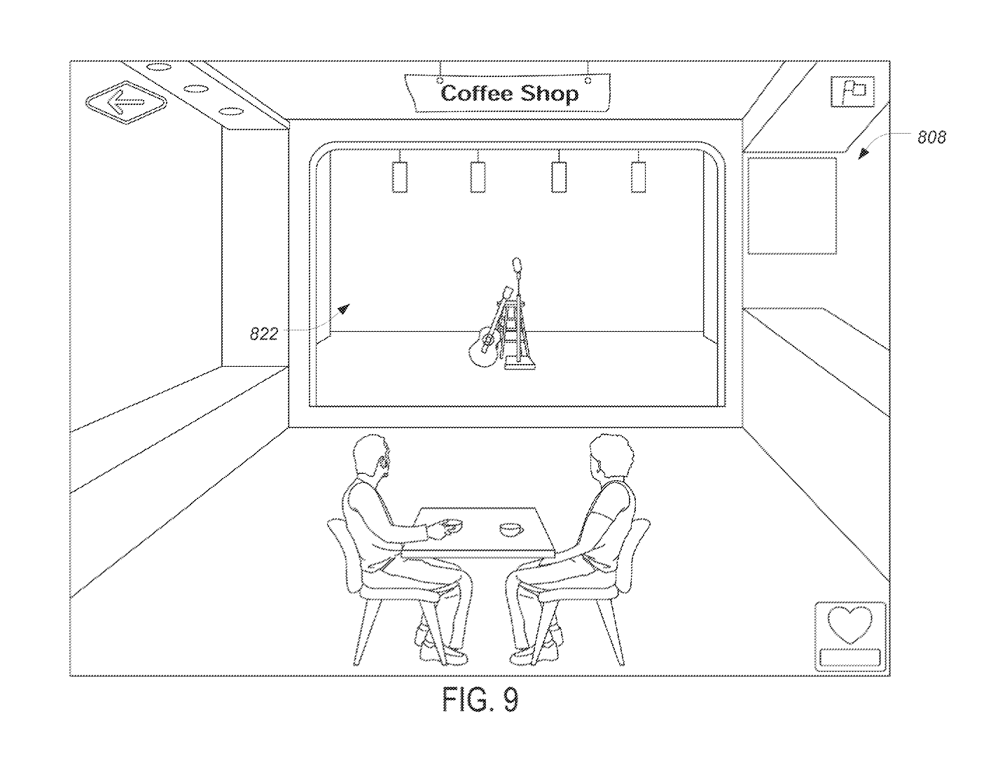

FIG. 9 illustrates one embodiment of a coffee shop venue 808. The coffee shop venue 808 may comprise a virtual representation of a generic coffee shop. In some embodiments, the coffee shop venue 808 may comprise a virtual representation of a chain coffee shop, such as, for example, a virtual representation of a Starbucks, Caribou, or other chain coffee shop. In some embodiments, the coffee shop venue 808 may comprise a virtual representation of a coffee shop associated with the virtual scene 306. For example, if the virtual scene represents Seattle, the coffee shop venue 808 may comprise a virtual representation of the Starbucks Coffee at Pike's Place Market. The coffee shop venue 808 may comprise a performance area 822, such as, for example, a virtual stage or a corner of the virtual coffee shop. In some embodiments, the coffee shop venue 808 may be associated with one or more performance genres typically found in a coffee shop, such as, for example, acoustic performances, soft rock, soft jazz, etc

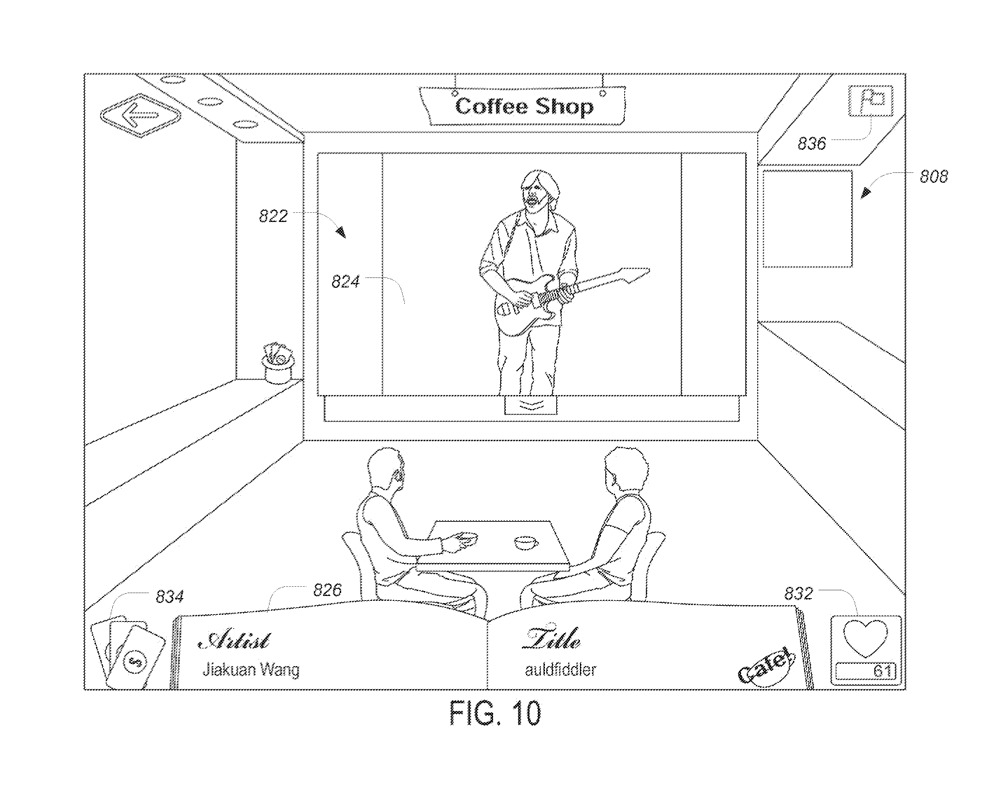

FIG. 10 illustrates one embodiment of the coffee shop venue 808 displaying a performance 824 in the performance area 822. In some embodiments, a venue, such as, for example, the coffee shop venue 808, may comprise an information display area 826. The information display area 826 may provide information related to the performance 824. For example, in some embodiments, the information display area 826 may identify the artist, the title, the genre, and/or other information associated with the displayed performance 824. The information display area 826 may also provide the user a link to the artist's Internet music purchasing site, such as the artist's iTunes store, to facilitate the user's purchase of the artist's music. In some embodiments, the venue 808 may comprise a pull-down button 828, a favorite button 832, a tip button 834, and/or a flag performance button 836. A user may interact with the pull-down button 828 to display a list of performances associated with the venue 808 and/or the displayed performance 826. A user may interact with the favorite button 832 to indicate the user likes the current performance 824, mark the displayed performance 824 as a favorite performance, to share the performance 824, for example, through social media and/or e-mail, or to provide a rating and/or applause to the displayed performance 824. The favorite button 832 may provide a score for the displayed performance indicating the number of users that have indicated the displayed performance 824 as a favorite performance and/or shared the performance. The displayed score may serve as a metric or measure of popularity of the displayed performance 824 among all users of the platform. A user may interact with the tip button 834 to provide a tip to the artist associated with the displayed performance 824. A user may interact with the flag performance button 836 to flag a performance as inappropriate and/or improper for the venue 808.

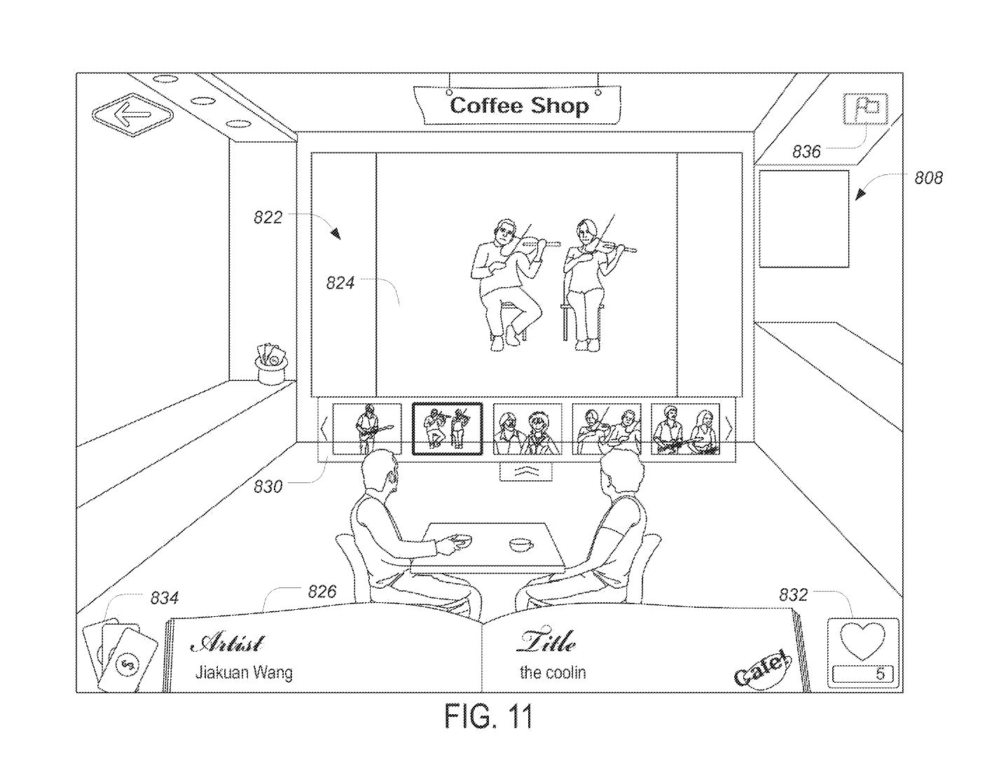

FIG. 11 illustrates one embodiment of the coffee shop venue 808 after a user has interacted with the pull-down button 828. A list of performances 830 may be displayed below the displayed performance 824. The list of performances 830 may comprise a list of performances with the same genre, musical style, artist, and/or fan base as the currently displayed performance. In some embodiments, the sequence of the list of performances 830 in a given venue 808 may be determined based on a calculation using, for example, a favorite performance score for a given performance, the number of instances that a given performance was selected to be a user's favorite, the number of instances that a given performance was shared, the number of instances that a given performance was chosen to provide a monetary tip to the artist, the user's location, and/or other user information. A user may select a new performance from the list of performances 830 to be displayed in the performance area 822. The list of performances 830 may be provided by a video service linked the promotional platform 100 and/or the client application 2, such as, for example, YouTube.

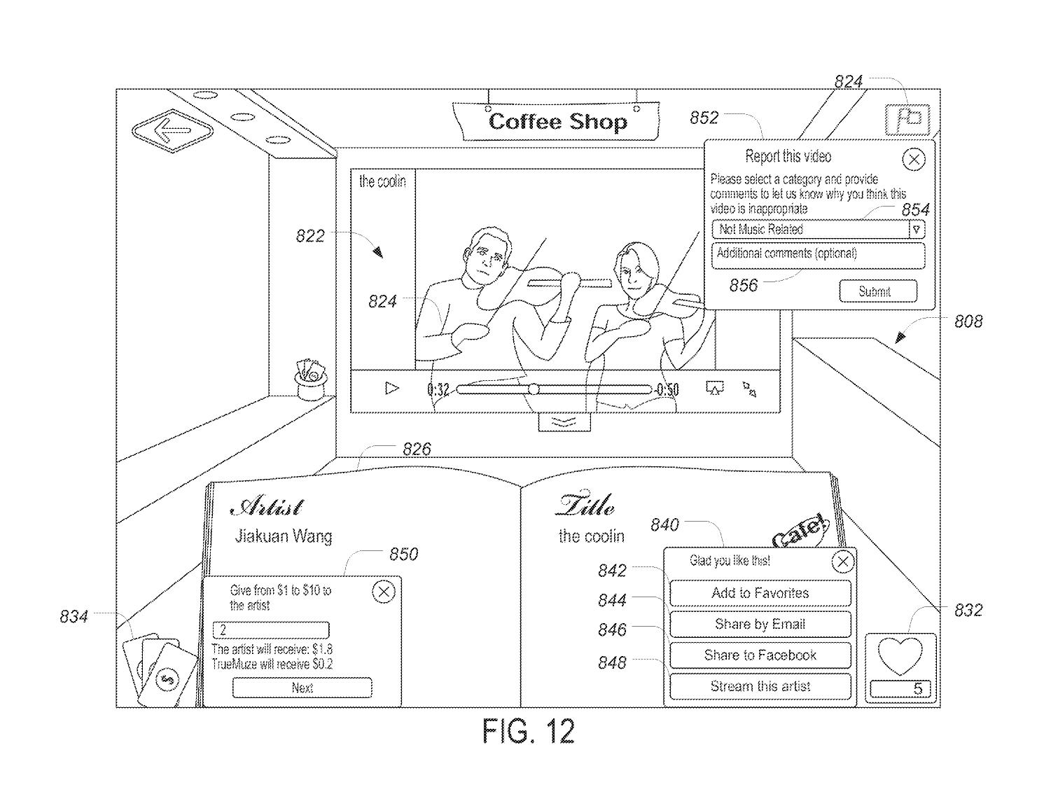

FIG. 12 illustrates one embodiment of the coffee shop venue 808 after a user has interacted with the favorite button 832, the tip button 834, and/or the flag performance button 836. In some embodiments, a user may interact with the favorite button 832 to display a favorite dialogue box 840. The favorite dialogue box 840 may comprise one or more interaction buttons 842-848. In some embodiments, a user may select an Add to Favorites button 842 to add the displayed performance 824 to a user's favorite list. The favorite list may allow a user to quickly access one or more performances, artists, and/or genres that the user has previously indicated as a favorite. In some embodiments, the favorite list may be used to generate new performance suggestions for the user. A user may access a favorites list to add, remove, or modify the favorite performances previously saved by the user. The favorite dialogue box 840 may comprise one or more sharing buttons 844, 846 to allow a user to share the displayed performance 824. For example, a share by e-mail button 844 may allow a user to share the displayed performance through one or more e-mail accounts linked to the user, the user device, and/or the promotional platform 100. A social media sharing button 846 may allow a user to share the displayed performance 824 via one or more social media platforms linked to the user, the user device, and/or the promotional platform 100, such as, for example, Facebook. In some embodiments, the favorite dialogue box 840 may comprise a streaming button 848. The user may select the streaming button 848 to stream additional performances by the artist associated with the displayed performance 824, or comprising the same or similar musical instruments or genres as that of the displayed performance.

In some embodiments, a user may interact with the tip button 834 to display a tip dialogue box 850. The tip dialogue box 850 may be configured to allow a user to provide a monetary tip to the artist associated with the displayed performance 824. In some embodiments, a portion of the tip may be kept by the promotional platform 100. For example, in the illustrated embodiment, a user provides a $2.00 tip to the artist. The artist receives 90%, or $1.80, of the tip. The performance platform 100 receives 10%, or $0.20, of the tip. In some embodiments, when a user elects to provide a tip to the artist, the performance platform 100 may initiate a financial transaction between an account associated with the user and an account associated with the artist and/or the performance platform 100. The performance platform 100 may access one or more online payment platforms, such as, for example, PayPal, to initiate the financial transaction between the user account and the artist/platform accounts.

In some embodiments, a venue, such as, for example, the coffee shop venue 808, may comprise a flag performance button 836. When a user interacts with the flag performance button 836, the client application 2 may display a flag performance dialogue box 852. The flag performance dialogue box 852 may provide a mechanism for a user to notify the promotional platform 100 that a performance is inappropriate and/or improper for the venue 808. For example, a drop-down box 854 may provide a plurality of reasons for flagging the displayed performance 824, such as, for example, the performance is not music related, the performance is not associated with the correct genre, the performance contains inappropriate and/or adult content, and/or the performance is not displaying correctly. An additional comments box 856 may allow a user to provide additional details regarding the reason for flagging the displayed performance 824.

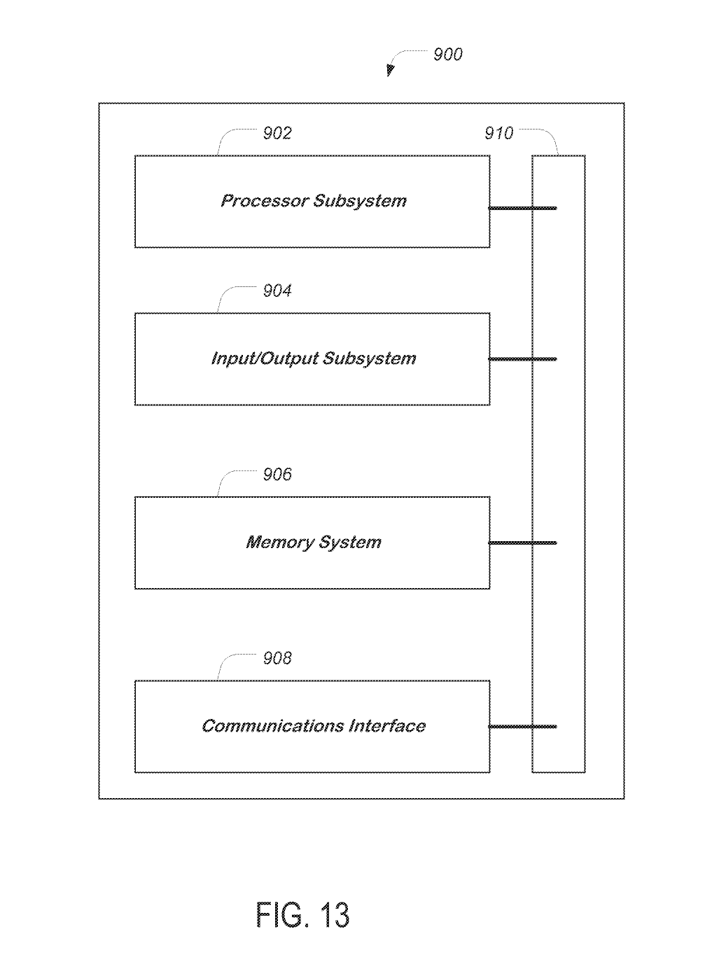

FIG. 13 is a schematic view of an illustrative electronic device 900 capable of implementing a client application and/or a promotional platform such as, for example, the client application 2 shown in FIG. 1. Electronic device 900 may comprise a processor subsystem 902, an input/output subsystem 904, a memory subsystem 906, a communications interface 908, and a system bus 910. In some embodiments, one or more of the electronic device 900 components may be combined or omitted such as, for example, not including the communications interface 908. In some embodiments, the electronic device 900 may comprise other components not combined or comprised in those shown in FIG. 13. For example, the electronic device 900 also may comprise a power subsystem. In other embodiments, the electronic device 900 may comprise several instances of the components shown in FIG. 13. For example, the electronic device 900 may comprise multiple memory subsystems 906. For the sake of conciseness and clarity, and not limitation, one of each of the components is shown in FIG. 13.

The processor subsystem 902 may comprise any processing circuitry operative to control the operations and performance of the electronic device 900. In various aspects, the processor subsystem 902 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, and/or other processing device. The processor subsystem 902 also may be implemented by a controller, a microcontroller, an application specific integrated circuit (ASIC), a field programmable gate array (FPGA), a programmable logic device (PLD), and so forth.

In various aspects, the processor subsystem 902 may be arranged to run an operating system (OS) and various mobile applications. Examples of an OS comprise, for example, operating systems generally known under the trade name of Apple iOS, Microsoft Windows OS, Android OS, and any other proprietary or open source OS. Examples of mobile applications comprise, for example, a telephone application, a camera (e.g., digital camera, video camera) application, a browser application, a multimedia player application, a gaming application, a messaging application (e.g., email, short message, multimedia), a viewer application, a promotional new music application, and so forth.

In some embodiments, the electronic device 900 may comprise a system bus 910 that couples various system components including the processing subsystem 902, the input/output subsystem 904, and the memory subsystem 906. The system bus 910 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for mobile computing device applications.

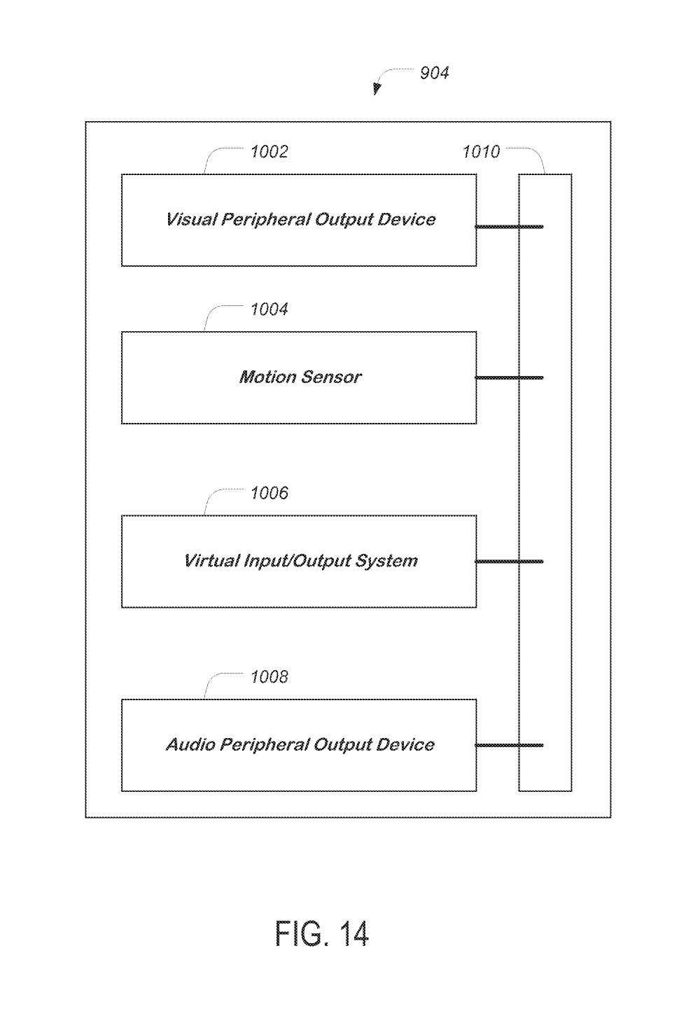

FIG. 14 shows one embodiment of the input/output subsystem 904 of the electronic device 900 shown in FIG. 13. The input/output subsystem 904 may comprise any suitable mechanism or component to at least enable a user to provide input to the electronic device 900 and the electronic device 900 to provide output to the user. For example, the input/output subsystem 904 may comprise any suitable input mechanism, including but not limited to, a button, keypad, keyboard, click wheel, touch screen, or motion sensor. In some embodiments, the input/output subsystem 904 may comprise a capacitive sensing mechanism, or a multi-touch capacitive sensing mechanism. Descriptions of capacitive sensing mechanisms can be found in U.S. Patent Application Publication No. 2006/0026521, entitled “Gestures for Touch Sensitive Input Device” and U.S. Patent Publication No. 2006/0026535, entitled “Mode-Based Graphical User Interfaces for Touch Sensitive Input Device,” both of which are incorporated by reference herein in their entirety. It will be appreciated that any of the input mechanisms described herein may be implemented as physical mechanical components, virtual elements, and/or combinations thereof.

In some embodiments, the input/output subsystem 904 may comprise specialized output circuitry associated with output devices such as, for example, an audio peripheral output device 1008. The audio peripheral output device 1008 may comprise an audio output including one or more speakers integrated into the electronic device 900. The speakers may be, for example, mono or stereo speakers. The audio peripheral output device 1008 also may comprise an audio component remotely coupled to audio peripheral output device 1008 such as, for example, a headset, headphones, and/or ear buds which may be coupled to the audio peripheral output device 1008 through the communications subsystem 908.

In some embodiments, the input/output subsystem 904 may comprise a visual peripheral output device 1002 for providing a display visible to the user. For example, the visual peripheral output device 1002 may comprise a screen such as, for example, a Liquid Crystal Display (LCD) screen, incorporated into the electronic device 900. As another example, the visual peripheral output device 1002 may comprise a movable display or projecting system for providing a display of content on a surface remote from the electronic device 900. In some embodiments, the visual peripheral output device 1002 can comprise a coder/decoder, also known as a Codec, to convert digital media data into analog signals. For example, the visual peripheral output device 1002 may comprise video Codecs, audio Codecs, or any other suitable type of Codec.

The visual peripheral output device 1002 also may comprise display drivers, circuitry for driving display drivers, or both. The visual peripheral output device 1002 may be operative to display content under the direction of the processor subsystem 902. For example, the visual peripheral output device 1002 may be able to play media playback information, application screens for application implemented on the electronic device 900, information regarding ongoing communications operations, information regarding incoming communications requests, or device operation screens, to name only a few.

In some embodiments, the input/output subsystem 904 may comprise a motion sensor 1004. The motion sensor 1004 may comprise any suitable motion sensor operative to detect movements of electronic device 900. For example, the motion sensor 1004 may be operative to detect acceleration or deceleration of the electronic device 900 as manipulated by a user. In some embodiments, the motion sensor 1004 may comprise one or more three-axis acceleration motion sensors (e.g., an accelerometer) operative to detect linear acceleration in three directions (i.e., the x or left/right direction, the y or up/down direction, and the z or forward/backward direction). As another example, the motion sensor 1004 may comprise one or more two-axis acceleration motion sensors which may be operative to detect linear acceleration only along each of x or left/right and y or up/down directions (or any other pair of directions). In some embodiments, the motion sensor 1004 may comprise an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

In some embodiments, the motion sensor 1004 may be operative to directly detect rotation, rotational movement, angular displacement, tilt, position, orientation, motion along a non-linear (e.g., arcuate) path, or any other non-linear motions. For example, when the motion sensor 1004 is a linear motion sensor, additional processing may be used to indirectly detect some or all of the non-linear motions. For example, by comparing the linear output of the motion sensor 1004 with a gravity vector (i.e., a static acceleration), the motion sensor 1004 may be operative to calculate the tilt of the electronic device 900 with respect to the y-axis. In some embodiments, the motion sensor 1004 may instead or in addition comprise one or more gyro-motion sensors or gyroscopes for detecting rotational movement. For example, the motion sensor 1004 may comprise a rotating or vibrating element.

In some embodiments, the motion sensor 1004 may comprise one or more controllers (not shown) coupled to the accelerometers or gyroscopes. The controllers may be used to calculate a moving vector of the electronic device 900. The moving vector may be determined according to one or more predetermined formulas based on the movement data (e.g., x, y, and z axis moving information) provided by the accelerometers or gyroscopes.

In some embodiments, the input/output subsystem 904 may comprise a virtual input/output system 1006. The virtual input/output system 1006 is capable of providing input/output options by combining one or more input/output components to create a virtual input type. For example, the virtual input/output system 1006 may enable a user to input information through an on-screen keyboard which utilizes the touch screen and mimics the operation of a physical keyboard or using the motion sensor 1004 to control a pointer on the screen instead of utilizing the touch screen. As another example, the virtual input/output system 1006 may enable alternative methods of input and output to enable use of the device by persons having various disabilities. For example, the virtual input/output system 1006 may convert on-screen text to spoken words to enable reading-impaired persons to operate the device.

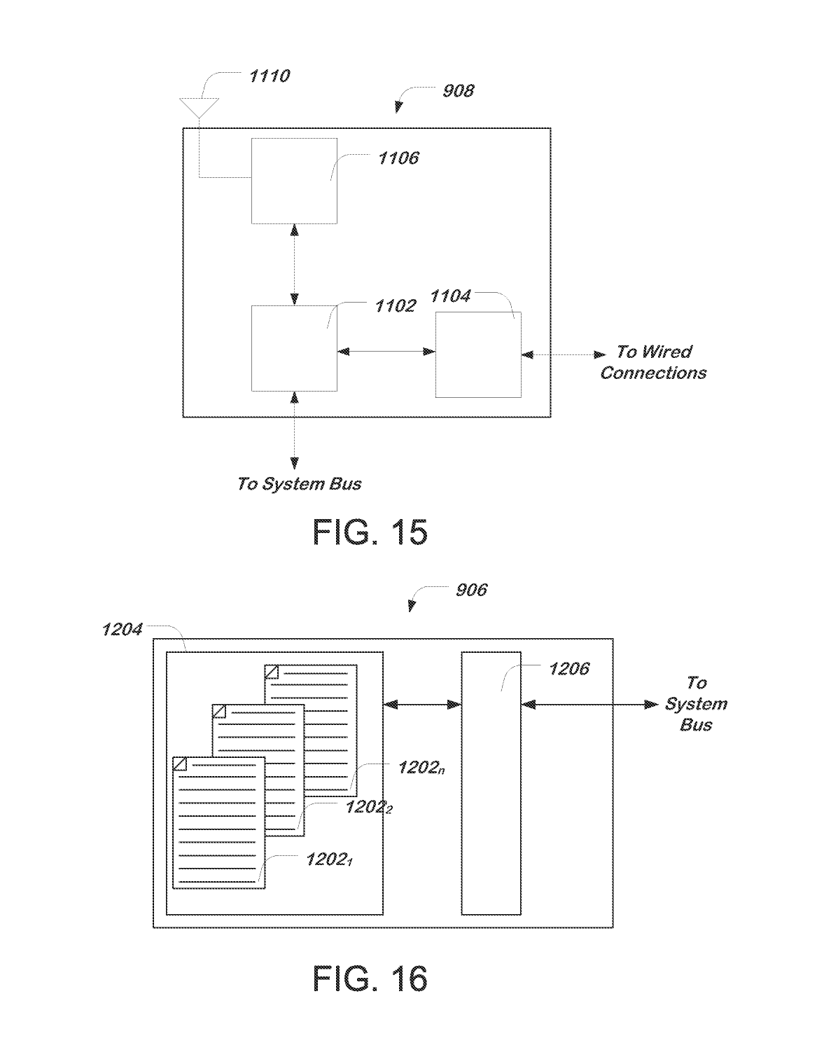

FIG. 15 shows one embodiment of the communication interface 908. The communications interface 908 may comprises any suitable hardware, software, or combination of hardware and software that is capable of coupling the electronic device 900 to one or more networks and/or devices. The communications interface 908 may be arranged to operate with any suitable technique for controlling information signals using a desired set of communications protocols, services or operating procedures. The communications interface 908 may comprise the appropriate physical connectors to connect with a corresponding communications medium, whether wired or wireless.

Vehicles of communication may comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 908 may comprise one or more interfaces such as, for example, a wireless communications interface 1106, a wired communications interface 1104, a network interface, a transmit interface, a receive interface, a media interface, a system interface, a component interface, a switching interface, a chip interface, a controller, and so forth. When implemented by a wireless device or within wireless system, for example, the communications interface 908 may comprise a wireless interface 1106 comprising one or more antennas 1110, transmitters, receivers, transceivers, amplifiers, filters, control logic, and so forth.

In various aspects, the communications interface 908 may provide voice and/or data communications functionality in accordance with different types of cellular radiotelephone systems. In various implementations, the described aspects may communicate over wireless shared media in accordance with a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In various implementations, the described aspects may comprise part of a cellular communication system. Examples of cellular communication systems may comprise CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

FIG. 16 shows one embodiment of the memory subsystem 906. The memory subsystem 906 may comprise any machine-readable or computer-readable media capable of storing data, including both volatile/non-volatile memory and removable/non-removable memory. The memory subsystem 906 may comprise at least one non-volatile memory unit 1202. The non-volatile memory unit 1202 is capable of storing one or more software programs 1204₁-1204ₙ. The software programs 1204₁-1204ₙ may contain, for example, applications, user data, device data, and/or configuration data, or combinations therefore, to name only a few. The software programs 1204₁-1204ₙ may contain instructions executable by the various components of the electronic device 900.

In various aspects, the memory subsystem 906 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In some embodiments, the memory subsystem 906 may contain a software program for implementing the client application 2 and/or the promotional platform 100 using the capabilities of the mobile computing device 900. In one embodiment, the memory subsystem 906 may contain an instruction set, in the form of a file 1204ₙ for executing the client application 2 and/or the promotional platform 100 on the mobile computing device 900. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 902.

Examples of handheld mobile devices suitable for implementing the system and method for new music and musician discovery using a mobile computing device comprise, but are not limited to: the Apple iPhone™ and iPod™; RIM Blackberry® Curve™, Pearl™, Storm™, and Bold™; Hewlett Packard Veer; Palm® (now HP) Pixi™, Pre™; Google Nexus S™, Motorola DEFY™, Droid (generations 1-3), Droid X, Droid X2, Flipside™, Atrix™, and Citrus™; HTC Incredible™, Inspire™, Surround™, EVO™, G2™, HD7, Sensation™, Thunderbolt™, and Trophy™, LG Fathom™, Optimus T™, Phoenix™, Quantum™, Revolution™, Rumor Touch™, and Vortex™, Nokia Astound™; Samsung Captivate™, Continuum™, Dart™, Droid Charge™ Exhibit™, Epic™, Fascinate™, Focus™, Galaxy S™, Gravity™, Infuse™, Replenish™, Seek™, and Vibrant™; Pantech Crossover; T-Mobile® G2™, Comet™, myTouch™; Sidekick®; Sanyo Zio™, Sony Ericsson Xperia™ Play.

Examples of tablet computing devices suitable for implementing the system and method for new music and musician discovery using a mobile computing device comprise, but are not limited to: Acer Iconia Tab A500, the Apple iPad™ (1 and 2), Asus Eee Pad Transformer, Asus Eee Slate, Coby Kyros, Dell Streak, Hewlett Packard TouchPad, Motorola XOOM, Samsung Galaxy Tab, Archos 101 internet tablet, Archos 9 PC tablet, Blackberry PlayBook, Hewlett Packard Slate, Notion ink Adam, Toshiba Thrive, and the Viewsonic Viewpad.

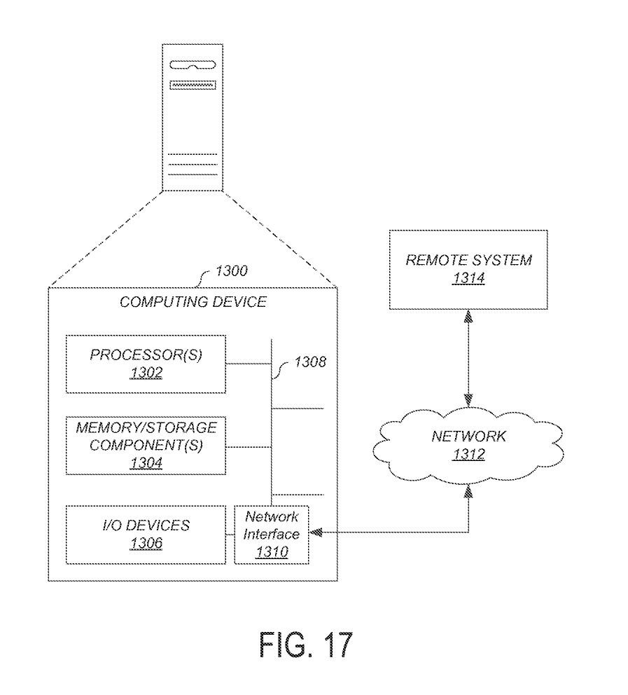

FIG. 17 shows one embodiment of a computing device 1300 which may implement one embodiment of the client application 2 and/or the promotional platform server 106. For the sake of clarity, the computing device 1300 is shown and described here in the context of a single computing device. It is to be appreciated and understood, however, that any number of suitably configured computing devices can be used to implement any of the described embodiments. For example, in at least some implementation, multiple communicatively linked computing devices are used. One or more of these devices can be communicatively linked in any suitable way such as via one or more networks (LANs), one or more wide area networks (WANs) or any combination thereof.

In this example, the computing device 1300 comprises one or more processor circuits or processing units 1302, one or more memory circuits and/or storage circuit component(s) 1304 and one or more input/output (I/O) circuit devices 1306. Additionally, the computing device 1300 comprises a bus 1308 that allows the various circuit components and devices to communicate with one another. The bus 1308 represents one or more of any of several types of bus structures, including a memory bus or local bus using any of a variety of bus architectures. The bus 1308 may comprise wired and/or wireless buses.

The processing unit 1302 may be responsible for executing various software programs such as system programs, applications programs, and/or module to provide computing and processing operations for the computing device 1300. The processing unit 1302 may be responsible for performing various voice and data communications operations for the computing device 1300 such as transmitting and receiving voice and data information over one or more wired or wireless communication channels. Although the processing unit 1302 of the computing device 1300 includes single processor architecture as shown, it may be appreciated that the computing device 1300 may use any suitable processor architecture and/or any suitable number of processors in accordance with the described embodiments. In one embodiment, the processing unit 1300 may be implemented using a single integrated processor.

The processing unit 1302 may be implemented as a host central processing unit (CPU) using any suitable processor circuit or logic device (circuit), such as a as a general purpose processor. The processing unit 1302 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 1302 may be coupled to the memory and/or storage component(s) 1304 through the bus 1308. The memory bus 1308 may comprise any suitable interface and/or bus architecture for allowing the processing unit 1302 to access the memory and/or storage component(s) 1304. Although the memory and/or storage component(s) 1304 may be shown as being separate from the processing unit 1302 for purposes of illustration, it is worthy to note that in various embodiments some portion or the entire memory and/or storage component(s) 1304 may be included on the same integrated circuit as the processing unit 1302. Alternatively, some portion or the entire memory and/or storage component(s) 1304 may be disposed on an integrated circuit or other medium (e.g., hard disk drive) external to the integrated circuit of the processing unit 1302. In various embodiments, the computing device 1300 may comprise an expansion slot to support a multimedia and/or memory card, for example.

The memory and/or storage component(s) 1304 represent one or more computer-readable media. The memory and/or storage component(s) 1304 may be implemented using any computer-readable media capable of storing data such as volatile or non-volatile memory, removable or non-removable memory, erasable or non-erasable memory, writeable or re-writeable memory, and so forth. The memory and/or storage component(s) 1304 may comprise volatile media (e.g., random access memory (RAM)) and/or nonvolatile media (e.g., read only memory (ROM), Flash memory, optical disks, magnetic disks and the like). The memory and/or storage component(s) 1304 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1306 allow a user to enter commands and information to the computing device 1300, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The computing device 1300 may comprise an alphanumeric keypad coupled to the processing unit 1302. The keypad may comprise, for example, a QWERTY key layout and an integrated number dial pad. The computing device 1300 may comprise a display coupled to the processing unit 1302. The display may comprise any suitable visual interface for displaying content to a user of the computing device 1300. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1302 may be arranged to provide processing or computing resources to the computing device 1300. For example, the processing unit 1302 may be responsible for executing various software programs including system programs such as operating system (OS) and application programs. System programs generally may assist in the running of the computing device 1300 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple iOS or other suitable OS in accordance with the described embodiments. The computing device 1300 may comprise other system programs such as device drivers, programming tools, utility programs, software libraries, application programming interfaces (APIs), and so forth.

The computer 1300 also includes a network interface 1310 coupled to the bus 1308. The network interface 1310 provides a two-way data communication coupling to a local network 1312. For example, the network interface 1310 may be a digital subscriber line (DSL) modem, satellite dish, an integrated services digital network (ISDN) card or other data communication connection to a corresponding type of telephone line. As another example, the communication interface 1310 may be a local area network (LAN) card effecting a data communication connection to a compatible LAN. Wireless communication means such as internal or external wireless modems may also be implemented.

In any such implementation, the network interface 1310 sends and receives electrical, electromagnetic or optical signals that carry digital data streams representing various types of information, such as the selection of goods to be purchased, the information for payment of the purchase, or the address for delivery of the goods. The network interface 1310 typically provides data communication through one or more networks to other data devices. For example, the network interface 1310 may effect a connection through the local network to an Internet Service Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 1310, which carry the digital data to and from the computer system 200, are exemplary forms of carrier waves transporting the information.

The computer 1300 can send messages and receive data, including program code, through the network(s) and the network interface 1310. In the Internet example, a server might transmit a requested code for an application program through the internet, the ISP, the local network (the network 1312) and the network interface 1310. In accordance with the invention, one such downloaded application provides for the identification and analysis of a prospect pool and analysis of marketing metrics. The received code may be executed by processor 1304 as it is received, and/or stored in storage device 1310, or other non-volatile storage for later execution. In this manner, computer 1300 may obtain application code in the form of a carrier wave.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as when it was individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

Various aspects of the subject matter described herein are set out in the following numbered clauses:

1. A computer-implemented method for a music discovery platform, the method comprising:

displaying, by a processor, a virtual scene, wherein the virtual scene comprises one or more venues;

receiving, by the processor, a selection of a first venue;

displaying, by the processor, the first venue, wherein the first venue comprises a venue type;

playing, by an audiovisual system, a performance, wherein the performance comprises a performance type.

2. The method of clause 1, wherein the venue type comprises at least one music genre, and wherein the performance type comprises the at least one music genre.

3. The method of clause 2, wherein the virtual scenery comprises an urban landscape.

4. The method of clause 3, wherein the performance comprises an audiovisual performance.

5. The method of clause 3, comprising displaying, by the processor, at least one of an artist name, an artist biography, a song name, an artist's location, a venue name, an artist's instruments, an artist's influences, an artist's appeal message for tips, a video title, a video description, a performance date, performance location, or any combination thereof, wherein the artist name, the artist biography, the song name, the artist's location, the venue name, the artist's instruments, the artist's influences, the artist's appeal message for tips, the video title, the video description, performance date, performance location, or other location information comprising location name or physical coordinates corresponding to a map location, or any combination thereof, is displayed commensurate with the playing of the performance.

6. The method of clause 3, comprising:

receiving, by the processor, a favorite indicator, wherein the favorite indicator represents user preference for the performance; and

marking, by the processor, the performance as a favorite performance of the user.

7. The method of clause 6, comprising transmitting, by the processor, the favorite indicator to at least one social media platform.

8. The method of clause 3, comprising:

receiving, by the processor, a tip indicator comprising a tip amount to be provided to an artist associated with the performance; and

initiating, by the processor, a transaction to transfer the tip amount from a first account associated with the user to at least a second account associated with the performance.

9. The method of clause 8, wherein the transaction comprises:

transmitting a first percentage of the tip amount from the first account to a second account associated with the performance; and

transmitting a second percentage of the tip amount from the first account to a third account associated with the music discovery platform.

10. A computing device comprising:

a processor; and

a non-transitory computer-readable medium coupled to the processor, the non-transitory computer-readable medium configured to store computer program instructions that when executed by the processor are operable to cause the processor to:
display a virtual scene, wherein the virtual scene comprises one or more venues; receive a selection of a first venue;
display the first venue, wherein the first venue comprises a venue type; play a performance, wherein the performance comprises a performance type.

11. The computing device of clause 10, wherein the venue type is associated with at least one music genre, and wherein the performance type comprises the at least one music genre.

12. The computing device of clause 11, wherein the virtual scenery comprises an urban landscape.

13. The computing device of clause 12, wherein the performance comprises an audiovisual performance.

14. The computing device of clause 13, wherein the processor is further operable to display at least one of an artist name, an artist biography, a song name, an artist's location, a venue name, an artist's instruments, an artist's influences, an artist's appeal message for tips, a video title, a video description, a performance date, performance location, other location information comprising location name or physical coordinates corresponding to a map location, or any combination thereof, is displayed commensurate with the playing of the performance.

15. The computing device of clause 13, wherein the processor is further operable to:

receive a favorite indicator, wherein the favorite indicator represents user preference for the performance; and

store the performance as a favorite performance associated with the user.

16. The computing device of clause 15, wherein the processor is further operable to transmit the favorite indicator to at least one social media platform.

17. The computing device of clause 16, wherein the processor is further operable to:

receive a tip indicator comprising a tip amount to be provided to an artist associated with the performance; and

initiate a transaction to transfer the tip amount from a first account associated with the user to at least a second account associated with the performance.

18. A computer-implemented method for promotion of new music, the method comprising:

providing, by a server, a virtual scene to a client device, wherein the virtual scene comprises at least one venue;

receiving, by the server, a venue selection of a first venue from the client device;

providing, by the server, the first venue to the client device, wherein the first venue comprises at least one genre type, and wherein the first venue comprises a virtual representation of at least one real-world location associated with music performances;

providing, by the server, a performance to the client device, wherein the performance comprises the at least one genre type, and wherein the performance is displayed on the client device within the first venue.

19. The computer-implemented method of clause 18, comprising:

providing, by the server, performance information to the client device, wherein the performance information comprises an artist name, an artist biography, a song name, performance location, other location information comprising location name or physical coordinates corresponding to a map location, or any combination thereof, is displayed commensurate with the playing of the performance, and wherein the performance information is displayed by the client device.

20. The computer-implemented method of clause 19, comprising:

receiving, by the server, a notification to share the performance information with at least one social media platform; and

transmitting, by the server, the performance information to the at least one social media platform.

What is claimed is:

1. A computer-implemented method for a music and musician discovery platform, the method comprising:
displaying, by a processor, a virtual scene, wherein the virtual scene comprises one or more venues;
receiving, by the processor, a selection of a first venue;
displaying, by the processor, the first venue, wherein the first venue comprises a venue type;
playing, by an audiovisual system, a performance, wherein the performance comprises a performance type.

2. The method of claim 1, wherein the venue type comprises at least one music genre, and wherein the performance type comprises the at least one music genre.

3. The method of claim 2, wherein the virtual scenery comprises an urban landscape.

4. The method of claim 3, wherein the performance comprises an audiovisual performance.

5. The method of claim 3, comprising displaying, by the processor, at least one of an artist name, an artist biography, a song name, an artist's location, a venue name, an artist's instruments, an artist's influences, an artist's appeal message for tips, a video title, a video description, a performance date, or any combination thereof, wherein the artist name, the artist biography, the song name, the artist's location, the venue name, the artist's instruments, the artist's influences, the artist's appeal message for tips, the video title, the video description, performance date, performance location, other location information comprising location name or physical coordinates corresponding to a map location, or any combination thereof, is displayed commensurate with the playing of the performance.

6. The method of claim 3, comprising:
receiving, by the processor, a favorite indicator, wherein the favorite indicator represents user preference for the performance; and
marking, by the processor, the performance as a favorite performance of the user.

7. The method of claim 6, comprising transmitting, by the processor, a link to a performance, an artist name, or a song name, or any combination thereof, to a social media platform.

8. The method of claim 3, comprising:
receiving, by the processor, a tip indicator comprising a tip amount to be provided to an artist associated with the performance; and
initiating, by the processor, a transaction to transfer the tip amount from a first account associated with the user to at least a second account associated with the performance.

9. The method of claim 8, wherein the transaction comprises:
transmitting a first percentage of the tip amount from the first account to a second account associated with the performance; and
transmitting a second percentage of the tip amount from the first account to a third account associated with the music discovery platform.

10. A computing device comprising:
a processor; and
a non-transitory computer-readable medium coupled to the processor, the non-transitory computer-readable medium configured to store computer program instructions that when executed by the processor are operable to cause the processor to:
display a virtual scene, wherein the virtual scene comprises one or more venues;
receive a selection of a first venue;
display the first venue, wherein the first venue comprises a venue type;
play a performance, wherein the performance comprises a performance type.

11. The computing device of claim 10, wherein the venue type is associated with at least one music genre, and wherein the performance type comprises the at least one music genre.

12. The computing device of claim 11, wherein the virtual scenery comprises an urban landscape.

13. The computing device of claim 12, wherein the performance comprises an audiovisual performance.

14. The computing device of claim 13, wherein the processor is further operable to display at least one of an artist name, an artist biography, a song name, an artist's location, a venue name, an artist's instruments, an artist's influences, an artist's appeal message for tips, a video title, a video description, a performance date, performance location, other location information comprising location name or physical coordinates corresponding to a map location, or any combination thereof, displayed commensurate with the playing of the performance.

15. The computing device of claim 13, wherein the processor is further operable to:
receive a favorite indicator, wherein the favorite indicator represents user preference for the performance; and
store the performance as a favorite performance associated with the user.

16. The computing device of claim 15, wherein the processor is further operable to transmit a link to a performance, an artist name, a song name, or any combination thereof, to a social media platform.

17. The computing device of claim 16, wherein the processor is further operable to:
receive a tip indicator comprising a tip amount to be provided to an artist associated with the performance; and
initiate a transaction to transfer the tip amount from a first account associated with the user to at least a second account associated with the performance.

18. A computer-implemented method for promotion of new music, the method comprising:
providing, by a server, a virtual scene to a client device, wherein the virtual scene comprises at least one venue;
receiving, by the server, a venue selection of a first venue from the client device;
providing, by the server, the first venue to the client device, wherein the first venue comprises at least one genre type, and wherein the first venue comprises a virtual representation of at least one real-world location associated with music performances;
providing, by the server, a performance to the client device, wherein the performance comprises the at least one genre type, and wherein the performance is displayed on the client device within the first venue.

19. The computer-implemented method of claim 18, comprising providing, by the server, performance information to the client device, wherein the performance information comprises, at least one of an artist name, an artist biography, a song name, an artist's location, a venue name, an artist's instruments, an artist's influences, an artist's appeal message for tips, a video title, a video description, a performance date, performance location, other location information comprising location name or physical coordinates corresponding to a map location, or any combination thereof, is displayed commensurate with the playing of the performance.

20. The computer-implemented method of claim 19, comprising:
receiving, by the server, a notification to share the performance information with at least one social media platform; and
transmitting, by the server, the performance information to the at least one social media platform.
